(19) United States
(12) Patent Application Publication
(10) Pub. No.: US 2025/0278596 A1
(43) Pub. Date: Sep. 4, 2025

(54) LIGHTWEIGHT ARTIFICIAL INTELLIGENCE COMPUTING DEVICE AND METHOD BASED ON NOC STRUCTURE

(71) Applicant: Korea Electronics Technology Institute, Seongnam-si (KR)

(72) Inventors: Hyeon Seong KIM, Seongnam-si (KR); Byung Soo KIM, Yongin-si (KR)

(21) Appl. No.: 19/210,261

(22) Filed: May 16, 2025

Related U.S. Application Data
(63) Continuation of application No. PCT/KR2023/019396, filed on Nov. 29, 2023.

(30) Foreign Application Priority Data
Nov. 29, 2022 (KR) 10-2022-0163505

(51) Int. Cl. G06N 3/04

(52) U.S. Cl. CPC G06N 3/04

(57) ABSTRACT

Proposed are a lightweight artificial intelligence computing device and a method based on a network-on-chip (NoC) structure. The device may include a neuron facility module including multiple neuron cells, a tile facility module including one or more neuron facility modules, and a cluster facility module including one or more tile facility modules. The cluster facility module may transfer a feature vector to the tile facility module. The tile facility module may transfer the feature vector to the neuron facility module. The neuron facility module may calculate distance information between the feature vector and a center point vector of each of the multiple neuron cells and generate minimum distance information of the neuron facility module on the basis of the result of the calculation.

### CROSS REFERENCE TO RELATED APPLICATIONS

This is a continuation application of International Patent Application No. PCT/KR2023/019396 filed on Nov. 29, 2023, which claims priority to Korean patent application No. 10-2022-0163505 filed on Nov. 29, 2022, contents of each of which are incorporated herein by reference in their entireties.

### BACKGROUND

### Technical Field

The present disclosure relates to a device and method for processing artificial intelligence (AI) computation.

### Description of Related Technology

An artificial intelligence (AI) computation processing device that supports on-chip learning based on low-complexity computation of a restricted coulomb energy neural network (RCE-NN) algorithm is capable of not only simple image classification but also motion recognition and situational awareness based on various sensor data information. In addition, it is possible to process data with high computational complexity or different types of data by embedding many neurons in the device.

### SUMMARY

One aspect is a lightweight artificial intelligence (AI) computation processing device and method that have scalability and flexibility by utilizing a hardware architecture structure based on a network-on-chip (NoC) structure.

Another aspect is a lightweight AI computation processing device and method that can retain a critical path of a controller and a hardware operating frequency through router control based on a hierarchical (H)-star structure irrespective of an increase in the number of neurons.

Another aspect is a lightweight AI computation processing device and method that can set any number of nodes in each layer even from the same number of neurons on the basis of a hierarchical hardware architecture structure to perform the learning and recognition function of AI.

Objects of the present disclosure are not limited to those described above, and other objects which have not been described will be clearly understood by those skilled in the art from the following description.

Another aspect is a lightweight artificial intelligence (AI) computation processing device including a neuron facility module including a plurality of neuron cells, a tile facility module including one or more neuron facility modules, and a cluster facility module including one or more tile facility modules.

The cluster facility module transmits a feature vector to the tile facility modules, the tile facility modules transmit the feature vector to the neuron facility modules, and the neuron facility modules calculate distance information between the feature vector and a center point vector of each of the plurality of neuron cells and generate minimum distance information of the neuron facility modules on the basis of calculation results.

Each of the tile facility modules may generate minimum distance information of the tile facility module by determining a minimum of the minimum distance information of the one or more neuron facility modules, and the cluster facility module may generate minimum distance information of the cluster facility module by determining a minimum of the minimum distance information of the one or more tile facility modules.

Each of the neuron facility modules may identify a neuron cell having a center point vector of which a distance from the feature vector is shortest among the plurality of neuron cells and transmit information on the identified neuron cell to the tile facility module together with a minimum of the distance information.

Another aspect is a neuron facility device including a neuron router and a plurality of neuron cells.

The neuron router receives a feature vector from a tile router and transmits the feature vector to the plurality of neuron cells, each of the neuron cells calculates distance information between the feature vector and a center point vector preset for the neuron cell and transmits the distance information to the neuron router, and the neuron router calculates a minimum of the distance information received from the plurality of neuron cells and transmits the minimum of the distance information to the tile router.

The neuron router may identify a neuron cell that has transmitted the minimum of the distance information and transmit information on the identified neuron cell to the tile router together with the minimum of the distance information.

The neuron router may determine a neuron cell to which a control signal will be transmitted among the plurality of neuron cells on the basis of a predesignated maximum node setting value.

Another aspect is a lightweight AI computation processing method including an operation in which a cluster facility module externally receives a feature vector, a multicasting operation in which the cluster facility module transmits the feature vector to a plurality of tile facility modules included in the cluster facility module and the plurality of tile facility modules transmit the feature vector to a plurality of neuron facility modules included in each of the plurality of tile facility modules, an operation in which the plurality of neuron facility modules calculate distance information between the feature vector and a center point vector of each of the plurality of neuron cells included in each of the plurality of neuron facility modules, and an operation in which the plurality of neuron facility modules generate minimum distance information of the plurality of neuron facility modules by determining a minimum of the distance information, the tile facility modules generate minimum distance information of the plurality of tile facility modules by determining a minimum of the minimum distance information of the plurality of neuron facility modules, and the cluster facility module generates minimum distance information of the cluster facility module by determining a minimum of the minimum distance information of the plurality of tile facility modules.

According to an embodiment of the present disclosure, it is possible to freely expand a lightweight artificial intelligence (AI) computation processing device in accordance with the application, and maintain the computational speed of the lightweight AI computation device even when the number of neurons increases.

The lightweight AI computation device and method according to the present disclosure have the following effects.
(1) A network-on-chip (NoC)-based lightweight AI hardware architecture prevents a hardware operating frequency from being reduced by an increasing number of neurons and makes it possible to develop a high-speed lightweight AI computation processing device in accordance with a user environment.
(2) Since any number of nodes can be set for each layer, it is possible to freely expand the design of an AI hardware device in accordance with the required number of neurons.
(3) Since it is unnecessary to modify control logic to expand an AI device, the design time of an AI device can be reduced.

Effects of the present disclosure are not limited to those described above, and other effects which have not been described will be clearly understood by those skilled in the technical field to which the present disclosure pertains from the following description.

### BRIEF DESCRIPTION OF THE DRAWINGS

FIG. 1 is a block diagram showing a hardware architecture structure of a lightweight artificial intelligence (AI) computation processing device according to an embodiment of the present disclosure.

FIGS. 2A to 2E are block diagrams showing detailed configurations of hardware modules of the lightweight AI computation processing device according to the embodiment of the present disclosure.

FIG. 3 is a flowchart illustrating a lightweight AI computation processing method according to an embodiment of the present disclosure.

### DETAILED DESCRIPTION

To design lightweight AI hardware suited to a user environment, a technique for designing hardware that is reconfigurable in accordance with the number of neurons is essential, but an increase in the number of neurons required with an increase in the complexity and volume of data to be processed makes it difficult to design a scalable AI hardware device. The fan-in and fan-out of neuron signals increasing with an increase in the number of neurons in a controller that supports multicast communication of the RCE-NN algorithm causes a high critical path in the control logic, reducing the operating frequency of the AI device.

With respect to an artificial intelligence (AI) computation processing device and method, a lightweight AI computation processing device and method according to the present disclosure have the following differences from the conventional art.
(1) Unlike a conventional hardware architecture structure in which a single controller controls all neurons, the weight AI computation processing device and method according to the present disclosure utilize a network-on-chip (NoC) structure such that a plurality of controllers separately control neurons in groups and a higher-level controller controls lower-level controllers in a hierarchy.
(2) In the NoC structure, the maximum number of nodes that may be controlled by a controller of each layer is limited on the basis of a hierarchical (H)-star topology such that each controller can maintain a certain critical path.
(3) Due to a hierarchical hardware architecture structure, it is possible to increase the number of neurons without additionally changing control logic to maintain the operating frequency of an AI device even when the number of nodes is variably reset.

The advantages and features of the present disclosure and a method of achieving them will become apparent from embodiments which will be described in detail below with reference to the accompanying drawings. However, the present disclosure is not limited to the embodiments disclosed below and may be implemented in various different forms. The embodiments are only provided to make the disclosure of the present disclosure complete and fully convey the scope of the present disclosure to those skilled in the technical field to which the present disclosure pertains. The present disclosure is only defined by the scope of the claims. Meanwhile, terminology used herein is only for the purpose of describing embodiments and is not intended to limit the present disclosure. In this specification, singular forms include plural forms as well unless the context particularly indicate otherwise. The terms “comprises” and/or “comprising” used in this specification do not preclude the presence or addition of one or more components, steps, operations, and/or devices other than stated components, steps, operations, and/or devices.

In describing the present disclosure, when detailed description of an associated known technology is determined to unnecessarily obscure the subject matter of the present disclosure, the detailed description will be omitted.

Hereinafter, embodiments of the present disclosure will be described in detail with reference to the accompanying drawings. In describing the present disclosure, to facilitate overall understanding, the same reference numeral will be used for the same means throughout the drawings.

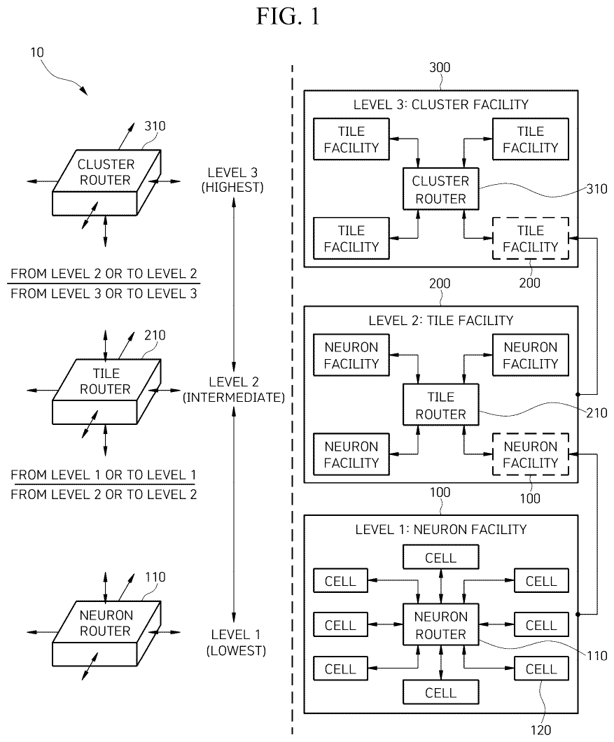

FIG. 1 is a block diagram showing a hardware architecture structure of a lightweight AI computation processing device according to an embodiment of the present disclosure.

A lightweight AI computation processing device 10 (hereinafter, “AI computation processing device”) according to an embodiment of the present disclosure includes a cluster facility module 300.

The cluster facility module 300 includes a cluster router 310 and one or more tile facility modules 200. Also, each of the tile facility modules 200 includes a tile router 210 and one or more neuron facility modules 100. Each of the neuron facility modules 100 includes a neuron router 110 and one or more neuron cells 120.

The hardware architecture structure of the AI computation processing device 10 proposed by the present disclosure is based on an H-star topology of an NoC structure and processes restricted coulomb energy neural network (RCE-NN) algorithm computation through the router controllers 110, 210, and 310 that exist in three layers as shown in FIG. 1.

In the AI computation processing device 10, the neuron facility modules 100 correspond to the lowest layer which is a first level, and the neuron routers 110 of the neuron facility modules 100 transmit and receive data to and from each neuron cell 120 and transmit and receive data to and from the tile routers 210 of tile facility modules 200 including the neuron facility modules 100.

The tile facility modules 200 correspond to a second level, and the tile routers 210 of the tile facility modules 200 transmit and receive data to and from the neuron routers 110 of the neuron facility modules 100 included in the corresponding tile facility modules 200 and transmit and receive data to and from the cluster router 310 of the cluster facility module 300 including the tile facility modules 200.

The cluster facility module 300 corresponds to the highest layer which is a third level, and the cluster router 310 of the cluster facility module 300 transmits and receives data to and from the tile routers 210 of the tile facility modules 200 included in the corresponding cluster facility modules 200 and transmits and receives data including feature data to and from an external device.

First, according to an RCE-NN algorithm, a feature vector input into the cluster router 310 is multicast from the highest layer which is the third level to each neuron cell 120 which is a lower-level node of a lowest-layer router in the first level through the second level. In the present disclosure, the term “feature vector” represents a case where feature data has the form of a vector.

In the case of training the neuron cells 120, a label value may be multicast to each neuron cell 120 on the same path as the feature vector. In this case, the neuron cell 120 may adjust a radius through training based on the feature vector and the label value.

Subsequently, each neuron cell 120 calculates distance information between the feature vector and a center point vector designated for the corresponding neuron cell 120 and transmits the distance information to the neuron router 110. Distance information calculated by the neuron cells 120 in the lowest layer is transmitted to higher-level routers (110→210→310). Each router 110, 210, and 310 determines a minimum of received distance information, and the cluster router 310 of the highest layer determines a final distance information minimum and generates learning and recognition results of the RCE-NN algorithm on the basis of the final distance information minimum.

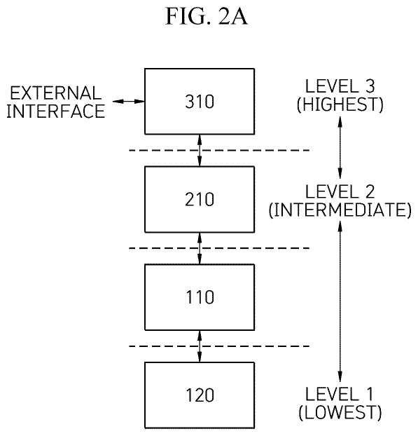

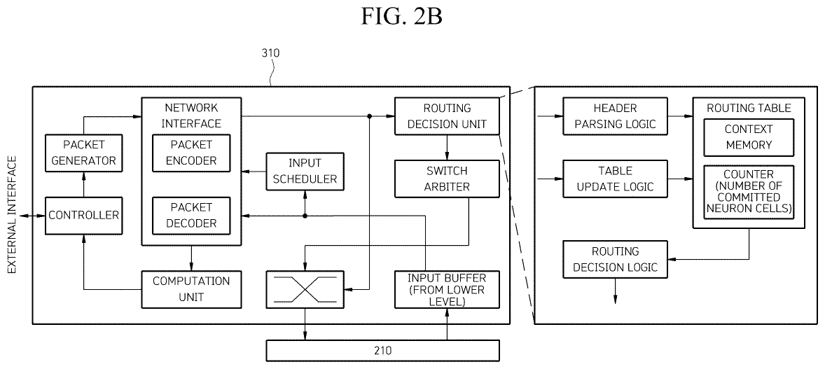

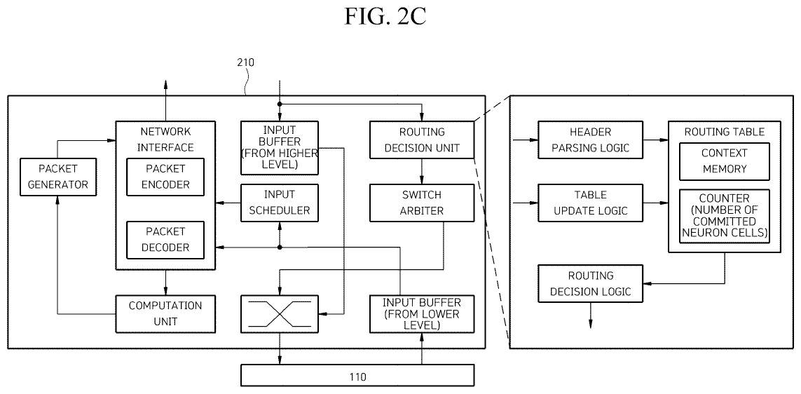

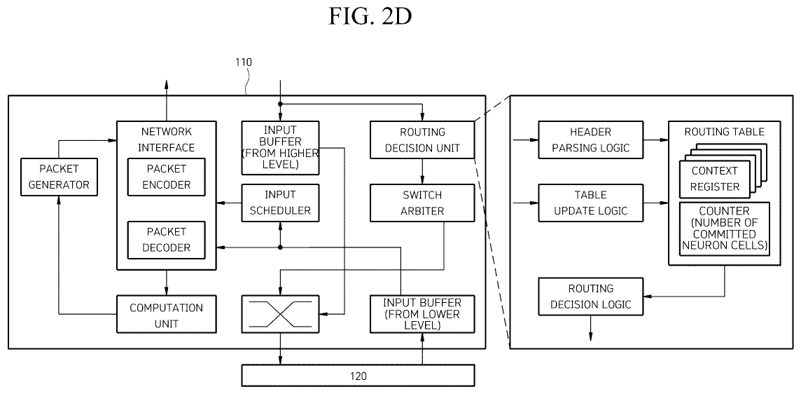

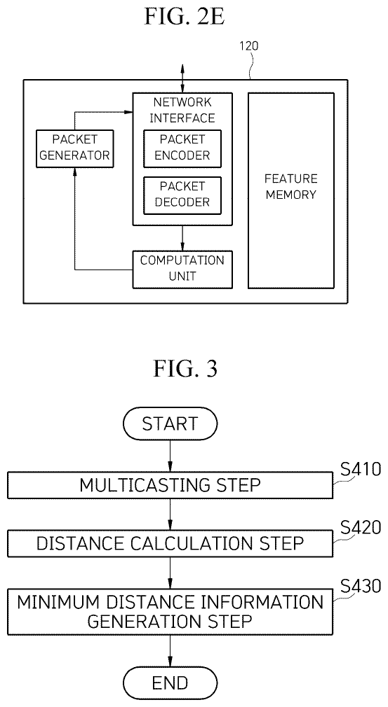

FIGS. 2A to 2E are block diagrams showing detailed configurations of hardware modules of the lightweight AI computation processing device according to the embodiment of the present disclosure.

To mitigate the problem of a critical path of the router controllers 110, 210, and 310 that may occur with an increase in the number of neurons, a hardware architecture structure of the AI computation processing device 10 according to the present disclosure is provided as shown in the block diagrams of hardware modules in FIGS. 2A to 2E. The AI computation processing device 10 employs distribution-based routing in which each of the router controllers 110, 210, and 310 has a routing table on the basis of an H-star topology. Also, a switch arbiter included in each of the router controllers 110, 210, and 310 has a setting value for the maximum number of nodes (neuron cells) that can be controlled by the corresponding router controller (hereinafter, “maximum node setting value”).

Therefore, even when the number of neurons increases, the AI computation processing device 10 has a fixed fan-in and fan-out in each of the router controllers 110, 210, and 310. In this way, the AI computation processing device 10 can prevent a hardware operating frequency from being reduced by an increasing number of neurons.

Meanwhile, the maximum node setting value may vary depending on the switch arbiter of each of the router controllers 110, 210, and 310. For example, in the AI computation processing device 10, any number of nodes may be set for each layer. In other words, the AI computation processing device 10 may have a different maximum node setting value for each layer. Also, switch arbiters of the same layer may have different maximum node setting values. As a specific example, when a plurality of neuron facility modules 100 are included in a specific tile facility module 200, switch arbiters of neuron routers 110 each included in the plurality of neuron facility modules 100 may have different maximum node setting values.

Functions of modules constituting the router controllers 110, 210, and 310 will be described below. Each of the router controllers 110, 210, and 310 includes an input buffer, a routing decision unit, a switch arbiter, a transmission unit, an input scheduler, a computation unit, a packet generator, and a network interface.

There are two types of input buffers: an input buffer (from top) that receives data packets from a higher-level routing controller and an input buffer (from bottom) that receives data packets from lower-level routing controllers or neuron cells. The network interface includes a packet encoder and a packet decoder.

For convenience, functions of the modules will be described below on the basis of the neuron routers 110. However, the description of functions of the modules in the neuron routers 110 may likewise apply to the modules with the same names in the tile routers 210 and the cluster router 310.

The input buffer (from top) of each neuron router 110 receives and stores a data packet that is transmitted from a tile router 210 of a tile facility module 200 to neuron facility modules 100.

The routing decision unit also receives the data packet. The routing decision unit extracts context information from the header of the data packet received from the tile router 210. The routing decision unit combines the context information with information on currently committed neuron cells 120 and generates routing information such that neuron cells 120 suited for the context information and neuron cells 120 having a neuron in a ready to learn (RTL) state may receive the data. To perform the above operation, the routing decision unit includes a header parsing logic, a routing table, a table update logic, and a routing decision logic. The routing table includes a counter that manages a plurality of context registers and a counter for managing the number of committed neuron cells and neuron cell information.

The switch arbiter transmits the data packet including the header and a control signal to a neuron cell 120 which is determined as a recipient, through the transmission unit in accordance with the routing information generated through the routing process of the routing decision unit. In this case, the transmission unit may read the data packet (the data packet received from the tile router 210) from the input buffer and then transmit the read data packet to the neuron cell 120 which is determined as the recipient in accordance with the routing information.

The neuron cell 120 calculates distance information between a feature vector and a center point vector in accordance with the received control information and transmits the calculated distance information to the neuron router 110.

Since a maximum node setting value is set in the switch arbiter as described above, the switch arbiter determines a range of controllable neuron cells 120 in accordance with the maximum node setting value and transmits the data packet and the control signal to the neuron cells 120 within the range. A plurality of neuron cells 120 may receive the data packet and the control signal.

The input buffer (from bottom) receives a data packet transmitted from a neuron cell 120 and transmits the received data packet to the input scheduler or the network interface. The data packet transmitted from the neuron cell 120 includes distance information, which is the distance information between the feature vector and a center point vector designated for the neuron cell 120.

The input scheduler determines whether a data packet is transmitted from a neuron cell 120. The network interface receives a data packet transmitted from a neuron cell 120 in accordance with a scheduling result of the input scheduler. The packet decoder included in the network interface decodes the data packet transmitted from the neuron cell 120 and transmits the decoded data packet to the computation unit.

The computation unit determines the minimum distance on the basis of distance information included in data packets transmitted from the plurality of neuron cells 120 and identifies a neuron cell 120 corresponding to the minimum distance. The computation unit transmits the minimum distance information and the corresponding neuron cell information (information on the neuron cell corresponding to the minimum distance) to the packet generator.

The packet generator generates a computation completion signal and a data packet including the minimum distance information and the neuron cell information corresponding to the minimum distance. The data packet and the computation completion signal generated by the packet generator are a packet and signal to be transmitted to the tile facility module 200.

The network interface encodes the data packet through the packet encoder and transmits the encoded data packet to the tile router 210 of the tile facility module 200.

Meanwhile, the neuron cell 120 includes a network interface, a feature memory, a computation unit, and a packet generator. The neuron cell 120 transmits and receives data and a control signal to and from the neuron router 110 through the network interface. The network interface of the neuron cell 120 includes a packet encoder and a packet decoder. The neuron cell 120 decodes the data packet received from the neuron router 110 and stores the feature vector included in the data packet in the feature memory. The computation unit of the neuron cell 120 calculates a distance between the feature vector and the center point vector designated for the neuron cell 120 to generate distance information. The packet generator of the neuron cell 120 generates a data packet on the basis of the distance information. The network interface of the neuron cell 120 encodes the data packet generated by the packet generator through the packet encoder and transmits the encoded data packet to the neuron router 110.

FIG. 3 is a flowchart illustrating a lightweight AI computation processing method according to an embodiment of the present disclosure.

The lightweight AI computation processing method according to the embodiment of the present disclosure may be performed by the lightweight AI computation processing device 10 and includes step S410 to step S430.

Step S410 is a multicasting step. The cluster router 310 of the cluster facility module 300 externally receives a feature vector.

The cluster router 310 transmits the feature vector to a tile facility module 200 included in the cluster facility module 300. The cluster facility module 300 may include a plurality of tile facility modules 200, and in this case, the cluster router 310 transmits the feature vector to the plurality of tile facility modules 200.

The tile router 210 of each tile facility module 200 transmits the feature vector to neuron facility modules 100 included in the tile facility module 200. The tile facility module 200 may include a plurality of neuron facility modules 100, and in this case, the tile router 210 transmits the feature vector to the plurality of neuron facility modules 100.

The neuron router 110 of each neuron facility module 100 transmits the feature vector to neuron cells 120 included in the neuron facility module 100. The neuron facility module 100 may include a plurality of neuron cells 120, and in this case, the neuron router 110 transmits the feature vector to the plurality of neuron cells 120.

Step S420 is a distance calculation step. Each neuron cell 120 receiving the feature vector calculates distance information between the feature vector and a center point vector designated for the neuron cell 120 and transmits the distance information to a neuron router 110. When a plurality of neuron cells 120 are included in each neuron facility module 100, a neuron router 110 receives distance information from the plurality of neuron cells 120.

Step S430 is a minimum distance information generation step. Each neuron router 110 calculates a distance information minimum of neuron cells 120 included in a neuron facility module 100 on the basis of the distance information received from the neuron cells. In other words, each neuron router 110 generates minimum distance information of a neuron facility module 100 and corresponding neuron cell information on the basis of distance information received from one or more neuron cells 120 included in the neuron facility module 100. The neuron router 110 transmits the minimum distance information of the neuron facility module 100 and neuron cell information corresponding to the minimum distance to a tile router 210.

Each tile router 210 generates minimum distance information of a corresponding tile facility module 200 on the basis of minimum distance information of each neuron facility module 100 received from the neuron facility module 100 included in a tile facility module 200. For example, each tile router 210 receives minimum distance information from a plurality of neuron routers 110 and designates a minimum among the plurality of pieces of minimum distance information as minimum distance information of a tile facility module 200. Also, the tile router 210 transmits the minimum distance information of the tile facility module 200 and neuron cell information corresponding to the minimum distance to the cluster router 310.

The cluster router 310 generates minimum distance information of the cluster facility module 300 on the basis of minimum distance information of each tile facility module 200 received from the tile facility module 200 included in the cluster facility module 300. For example, the cluster router 310 receives minimum distance information from a plurality of tile routers 210 and designates a minimum among the plurality of pieces of minimum distance information as minimum distance information of the cluster facility module 300. In other words, the cluster router 310 generates the minimum distance information of the cluster facility module 300 on the basis of the minimum distance information received from the plurality of tile routers 210. Also, the cluster router 310 may identify a neuron cell 120 corresponding to the minimum distance information of the cluster facility module 300 on the basis of the neuron cell information transmitted from the tile routers 210. The cluster router 310 may externally transmit any one of the minimum distance information of the cluster facility module 300 and neuron cell information corresponding to the minimum distance information of the cluster facility information of the cluster facility module 300.

The above lightweight AI computation processing method has been described with reference to the flowchart shown in the drawing. For simplicity, the method has been illustrated and described as a series of blocks, but the present disclosure is not limited to the order of blocks. Some blocks may be performed with other blocks in a different order from that illustrated and described in this specification or concurrently, and various other branches, flow paths, and orders of blocks that achieve the same or similar result may be implemented. In addition, all illustrated blocks may not be required for implementation of the method described in this specification.

Meanwhile, in the description of FIG. 3, each step may be subdivided into additional steps in accordance with an implementation example of the present disclosure, or steps may be combined into fewer steps. Also, some steps may be omitted as necessary, or the order of steps may change. Further, the description of FIGS. 1 to 2E may apply to FIG. 3 even when omitted. In addition, the description of FIG. 3 may apply to FIGS. 1 to 2E.

Although the present disclosure has been described above with reference to exemplary embodiments, those skilled in the art should understand that various modifications and alterations can be made without departing from the spirit and scope of the present disclosure stated in the following claims.

What is claimed is:

1. A lightweight artificial intelligence (AI) computation processing device comprising:
a neuron facility module including a plurality of neuron cells;
a tile facility module including one or more neuron facility modules; and
a cluster facility module including one or more tile facility modules,
wherein the cluster facility module is configured to transmit a feature vector to the one or more tile facility modules,
wherein the one or more tile facility modules are configured to transmit the feature vector to the one or more neuron facility modules, and
wherein the one or more neuron facility modules are configured to calculate distance information between the feature vector and a center point vector of each of the plurality of neuron cells and generate minimum distance information of the one or more neuron facility modules on the basis of calculation results.

2. The device of claim 1, wherein each of the one or more tile facility modules is configured to generate minimum distance information of the tile facility module by determining a minimum of the minimum distance information of the one or more neuron facility modules, and
wherein the cluster facility module is configured to generate minimum distance information of the cluster facility module by determining a minimum of the minimum distance information of the one or more tile facility modules.

3. The device of claim 1, wherein each of the one or more neuron facility modules is configured to identify a neuron cell having a center point vector of which a distance from the feature vector is shortest among the plurality of neuron cells and transmit information on the identified neuron cell to the one or more tile facility modules together with a minimum of the distance information.

4. A neuron facility device comprising:
a neuron router; and
a plurality of neuron cells,
the neuron router configured to receive a feature vector from a tile router and transmit the feature vector to the plurality of neuron cells,
each of the neuron cells configured to calculate distance information between the feature vector and a center point vector preset for each of the plurality of neuron cells and transmit the distance information to the neuron router, and
the neuron router configured to calculate a minimum of the distance information received from the plurality of neuron cells and transmit the minimum of the distance information to the tile router.

5. The device of claim 4, wherein the neuron router is configured to identify a neuron cell that has transmitted the minimum of the distance information, and transmit information on the identified neuron cell to the tile router together with the minimum of the distance information.

6. The device of claim 4, wherein the neuron router is configured to determine a neuron cell to which a control signal will be transmitted among the plurality of neuron cells on the basis of a predesignated maximum node setting value.
